(19) United States
(12) Patent Application Publication
(10) Pub. No.: US 2013/0309063 A1
(43) Pub. Date: Nov. 21, 2013

(54) TURBINE ENGINE FAN OR COMPRESSOR

(71) Applicants: Philippe Charles Octave Buyle, Sivry Courtry (FR); Andre Leroux, Samois Sur Seine (FR); David Tourin, La Rochette (FR); Christian Lanneree, Brunoy (FR); Philippe Sarnago, Samois Sur Seine (FR); Sebastien Bernard, Savigny Le Temple (FR)

(72) Inventors: Philippe Charles Octave Buyle, Sivry Courtry (FR); Andre Leroux, Samois Sur Seine (FR); David Tourin, La Rochette (FR); Christian Lanneree, Brunoy (FR); Philippe Sarnago, Samois Sur Seine (FR); Sebastien Bernard, Savigny Le Temple (FR)

(73) Assignee: SNECMA, Paris (FR)

(21) Appl. No.: 13/981,797

(22) PCT Filed: Jan. 25, 2012
(86) PCT No.: PCT/FR2012/050159

§ 371 Date: Jul. 25, 2013

(30) Foreign Application Priority Data
Jan. 28, 2011 (FR) 1150680

(51) Int. Cl. G01B 7/14; F01D 25/24

(52) U.S. Cl. CPC G01B 7/14; F01D 25/24
USPC 415/118

(57) ABSTRACT

A turbine engine stage including a rotor wheel including a plurality of blades surrounded on an outside by a casing including a layer of abradable material on its inside surface facing free ends of the blades. At least one plane sensor for measuring clearance at blade tips is carried by the inside surface of the casing and is covered by the layer of abradable material.

The present invention relates to a stage of a turbine engine comprising a rotor wheel and means for monitoring the clearance at the blade tips.

In conventional manner, a bypass turbine engine comprises, from upstream to downstream: a fan, at the outlet of which the stream of air is split into a primary air stream flowing inside the turbojet through a compressor, a combustion chamber, and a turbine; and a secondary air stream that flows around the turbojet.

The fan is formed by a rotary wheel comprising a disk carrying on its outer periphery a plurality of blades that are regularly spaced apart around the axis of the disk. A casing surrounds the outside of the blades. In order to avoid air passing over the tips of the blades, which would reduce the efficiency of the engine, a coating of abradable material is carried by the inside surface of the fan casing and is arranged in register with the blades of the fan.

In operation, it is important to monitor the clearance between the radially outer ends of the blades and the casing in order to maintain continuously a distance between the free ends of the blades and the casing that is minimized, but that is sufficient to avoid any contact that could harm the mechanical integrity of the fan blade and thus reduce its lifetime. It is also important to be aware of the vibratory behavior of the rotating blades.

For this purpose, proposals have been made to form a plurality of bosses on the outside surface of the casing, each boss having an orifice that opens out both to the inside and to the outside of the casing for receiving a capacitive type cylindrical sensor that is engaged so that its inside surface is substantially flush with the inside surface of the casing. The inside surface of the casing facing the radially outer ends of the blades is covered in abradable material, with the exception of the zones carrying the sensors. A cavity is thus formed between the active face of each sensor and the radially outer ends of the blades. These cavities are necessary to avoid any contact between the radially outer ends of the blades and the sensors.

During rotation of the fan wheel, the cavities generate high levels of sound nuisance because of the radially outer ends of the fan blades moving past the cavities at high speed.

Forming orifices in the bosses of the casing also leads to problems of mechanical strength if the casing is made of composite material, and this can lead to difficulties in obtaining the certifications required for selling the turbine engine.

Finally, such an arrangement of the sensors may lead to their active faces clogging up, which can give rise to measurement errors. In order to solve this difficulty, proposals have been made to fill the cavities with polyurethane foam. Nevertheless, that type of foam breaks up in operation.

A particular object of the invention is to provide a solution to these various problems that is simple, inexpensive, and effective.

To this end, the invention provides a turbine engine stage comprising a rotor wheel having a plurality of blades surrounded on the outside by a casing carrying a layer of abradable material on its inside surface facing the free ends of the blades, the stage being characterized in that at least one plane sensor for measuring the clearance at the blade tips is carried by the inside surface of the casing and is covered by the layer of abradable material.

The relatively heavy and bulky cylindrical sensors of the prior art are replaced by lightweight plane sensors of radial dimensions that are very small, thus enabling them to be placed directly on the inside surface of the casing. Furthermore, the use of plane sensors avoids the need to make bosses on the casing or to make holes in the casing, thereby enabling the mechanical strength of the casing to be improved and enabling sound nuisance to be reduced since the cavities facing the radially outer ends of the blades are omitted. Clogging up of the sensors is also avoided since they are protected by the abradable material. Finally, covering the sensors in the layer of abradable material enables them to be protected against moisture.

Advantageously, the plane sensor is a sensor of capacitive type. It is circular in shape with a diameter of the order of 30 millimeters (mm) and a thickness of less than 1 mm.

Advantageously, the sensor is covered by a layer of abradable material that is about 5 mm to 7 mm thick.

In a particular embodiment of the invention, three above-mentioned plane sensors are carried by the casing.

In a particular arrangement, a first sensor is placed in a lateral position, the other two sensors being positioned symmetrically on the casing on either side of the first sensor.

The other two sensors may be arranged in a top position and in a bottom position on the casing.

According to another characteristic of the invention, the casing includes at least one orifice for passing a cable for connection to the sensor, the orifice being positioned axially outside the zone in which the blades rotate, in such a manner as to avoid adding sound nuisance by forming air cavities in the axial zone where the radially outer ends of the blades go past.

Advantageously, the above-mentioned orifice is formed upstream from the leading edges of the blades.

The invention also provides a fan or a compressor including at least one stage as described above. The invention also provides a turbine engine, such as an airplane turbojet, comprising at least one fan or compressor stage, fitted with sensors for measuring blade tip clearance of the type described above.

Other advantages and characteristics of the invention appear on reading the following description made by way of nonlimiting example and with reference to the accompanying drawings, in which:

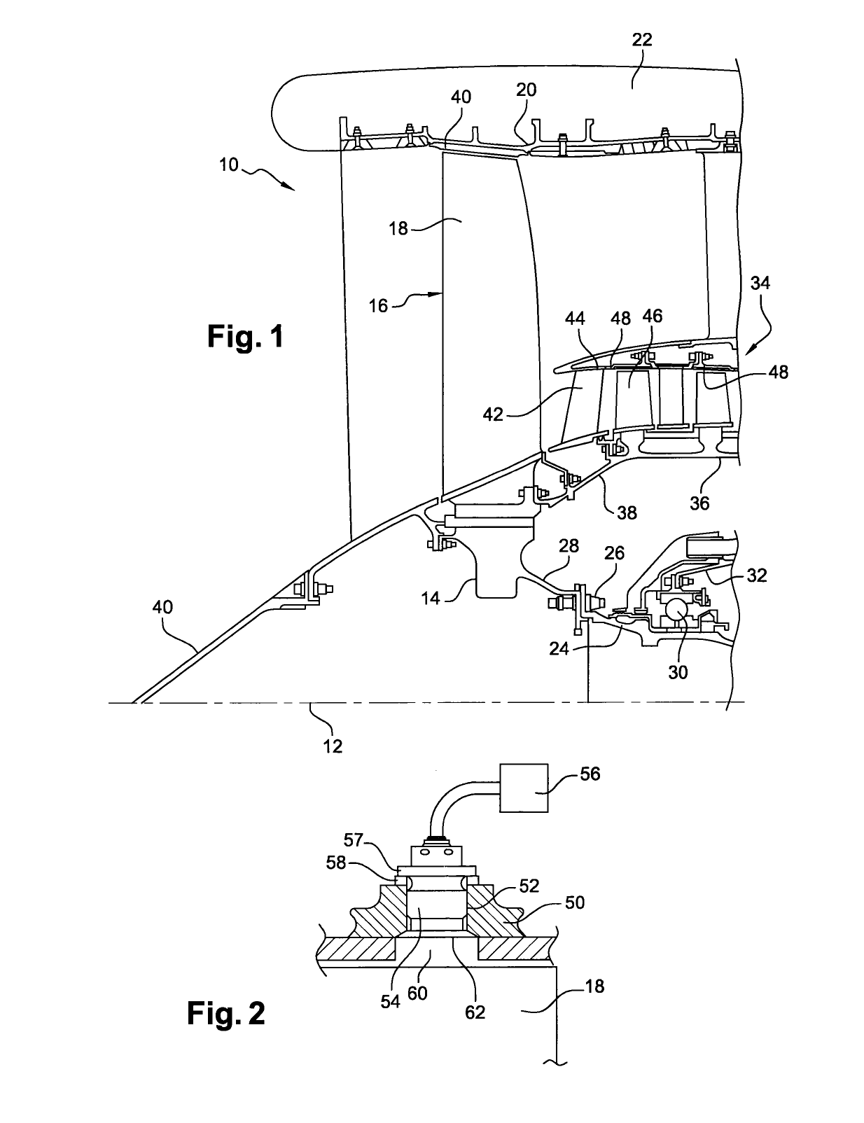

FIG. 1 is a diagrammatic half view in axial section of a turbojet fan;

FIG. 2 is a diagrammatic view in axial section of a prior art sensor carried by the casing of the FIG. 1 fan;

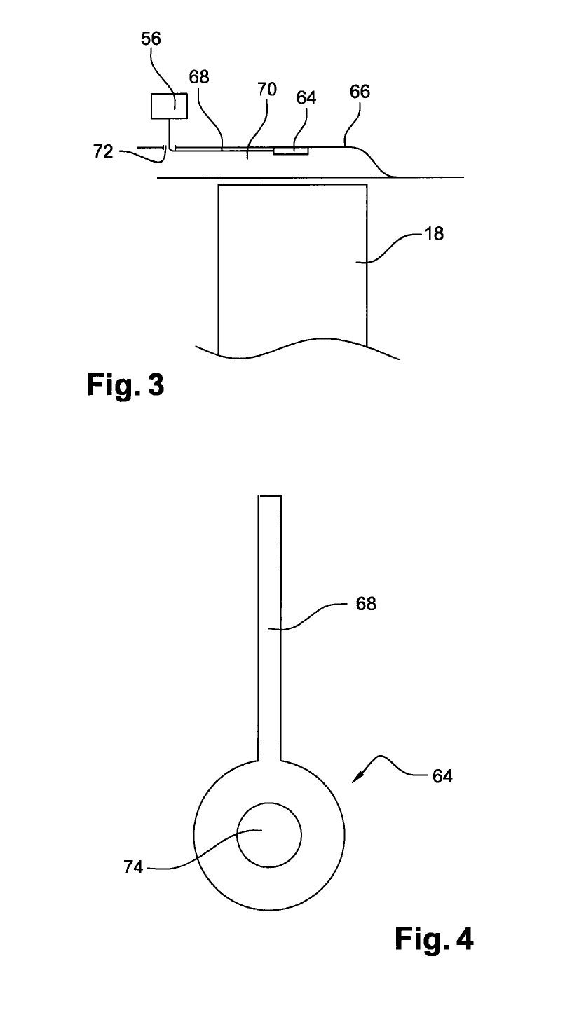

FIG. 3 is a diagram of an embodiment of the invention; and

FIG. 4 is a face view of a plane sensor used in the FIG. 3 embodiment.

Reference is made initially to FIG. 1, which shows a fan 10 of a turbine engine of axis 12, the fan comprising a wheel made up of a disk 14 carrying at its periphery a plurality of blades 16 having their roots engaged in slots in the disk 14 and having their airfoils 18 extending radially outwards towards a fan casing 20, the casing in turn carrying a nacelle 22 that surrounds the blades 16 on the outside. The fan wheel is driven in rotation about the axis 12 of the engine by a shaft 24 fastened by bolts 26 to a frustoconical wall 28 secured to the fan wheel. The shaft 24 is supported and guided by a bearing 30 that is carried by the upstream end of an annular support 32 fastened downstream to an intermediate casing (not shown) arranged downstream from a low-pressure compressor 34 having its rotor 36 secured to the fan wheel via a connection wall 38.

On an inside face, the fan casing 20 has a coating of abradable material 40 arranged in register with the blades 16 of the fan for the purpose of being worn away on making contact with the radially outer ends of the blades 16. This layer of abradable material 40 makes it possible to reduce the clearance between the tips of the blades 16 and the fan casing 20, thereby optimizing the performance of the engine.

The low-pressure compressor 34 comprises stationary vanes 42 carried by an outer casing 44 alternating with rotor wheels 46 carried by the rotor 36. Each rotor wheel 46 has a plurality of blades regularly distributed around the axis 12 of the engine and surrounded on the outside by a layer 48 of abradable material carried by the inside surface of the casing 44 of the low-pressure compressor.

In order to measure the clearances at the tips of the blades of the fan 10, a plurality of sensors are arranged on the casing 20 of the fan 10. The casing 20 has bosses 50 formed on its outer surface and circumferentially spaced apart from one another. Each boss 50 has an orifice 52 opening out to the inside of the casing 20 into the passage along which the air stream flows, and it contains a sensor 54 of substantially cylindrical shape that is connected by a cable to processor means 56. Each sensor 54 comprises an annular base 57 at its radially outer end. An annular spacer 58 is interposed between the base 57 and the outer surface of the boss 50. This spacer 58 serves to adjust the extent to which the sensor is inserted inside the orifice. Each sensor 54 is inserted from the outside of the casing into the inside of an orifice 52, and the thickness of the spacer 58 is such that the active face of the sensor is set back inside the orifice 52 from the opening of the orifice into the air flow passage. The layer of abradable material 40 covers the inside surface of the casing, with the exception of the outlets from the orifices 52. A cavity 60 is thus formed between the radially outer ends of the blades 18 and the active face 62 of each sensor 54.

As mentioned above, this type of configuration with cylindrical sensors 54 generates high levels of sound nuisance because of the blades moving past the cavities 60 at high speed.

The invention seeks to avoid that drawback, together with those mentioned above, by replacing the cylindrical sensors by plane sensors 64, and by covering them in a layer of abradable material 70 (FIG. 3).

Each sensor 64 is mounted on the inside surface of the casing 66 in register with the radially outer ends of the blades 18, and it is connected by a flat cable 68 to processor means 56 arranged outside the casing 66. The cable 68 travels over the inside surface of the casing 66 between the abradable layer 70 and the casing 66, and then passes through the casing via an orifice 72 formed upstream from the leading edges of the blades 18. In this way, the orifices 72 for passing the cables 68 of the sensors 64 are offset upstream from the zone in which the blades 18 rotate, thereby avoiding forming sound nuisance as a result of the blades going past at high speed.

A fine layer of abradable material is interposed between the sensor 64 and the inside surface of the casing 66 so as to provide initial adhesion between the sensor 64 and the casing 66 prior to putting the abradable layer 70 into place.

In a practical embodiment of the invention, the sensors 64 are circular in shape, and the abradable layer 70 covering the sensors has thickness lying in the range 5 mm to 7 mm. The diameter of the sensor 64 is about 30 mm and its thickness is less than 1 mm, for example it lies in the range 0.4 mm to 0.7 mm. The diameter of the active portion 74 of the sensor is about 8 mm to 9 mm.

Advantageously, the fan has three sensors, a first being arranged in a top position on the casing, i.e. at 12 o'clock, another sensor is arranged in a bottom position, i.e. diametrically opposite the first sensor, and the third sensor is arranged between the other two sensors at 90° from each of them.

By way of example, the sensors 64 for measuring the clearance at the tips of the blades are of the capacitive type. By covering the capacitive sensor in abradable material, it is possible to improve the measurement of the clearance at the tips of the blades compared with the prior technique because the permittivity of the abradable material is about twice that of air. By way of example, the abradable material may be a resin obtained by room temperature vulcanization (RTV) or it may be Minnesota Ec 3524®.

The above description with reference to a fan 10 of a turbine engine applies equally to any other portion of an engine that enables sensors 64 for measuring blade tip clearance to be installed in an abradable layer, as described above. In particular, the invention is applicable to the low-pressure compressor 34 of FIG. 1 that has layers of abradable material 48 facing the radially outer ends of its blades.

The orifices 72 for passing the cable 68 of the sensors 64 present a diameter of about 3 mm, which is much smaller than the diameter of the orifices 52 in which the sensors are installed in the prior art, which diameter may be about 30 mm. The orifices 72 are thus of section that is small enough to have no impact on the mechanical strength of the casing 66 in operation.

1-10. (canceled)

11. A turbine engine stage comprising:
a rotor wheel including a plurality of blades surrounded on an outside by a casing carrying a layer of abradable material on its inside surface facing free ends of the blades; and
at least one plane sensor for measuring clearance at blade tips carried by the inside surface of the casing and which is covered by the layer of abradable material.

12. A turbine engine stage according to claim 11, wherein the plane sensor is a sensor of capacitive type.

13. A turbine engine stage according to claim 11, wherein the plane sensor is circular in shape with a diameter of an order of 30 mm and a thickness of less than 1 mm.

14. A turbine engine stage according to claim 11, wherein the sensor is covered by a layer of abradable material that is about 5 mm to 7 mm thick.

15. A turbine engine stage according to claim 11, wherein at least three of the plane sensors are carried by the casing.

16. A turbine engine stage according to claim 15, wherein a first plane sensor of the three plane sensors is arranged in a lateral position, the other two plane sensors being positioned symmetrically on the casing on either side of the first plane sensor.

17. A turbine engine stage according to claim 16, wherein the other two plane sensors are arranged in a top position and a bottom position on the casing.

18. A turbine engine stage according to claim 11, wherein the casing includes at least one orifice for passing a cable for connection to the sensor, the orifice being positioned axially outside a zone in which the blades rotate.

19. A turbine engine stage according to claim 18, wherein the orifice is formed upstream from leading edges of the blades.

20. A turbine engine, or an airplane turbojet, comprising at least one stage including sensors for measuring blade tip clearance in accordance with claim 11.
